(19) United States
(12) Patent Application Publication
(10) Pub. No.: US 2026/0026428 A1
(43) Pub. Date: Jan. 29, 2026

(54) ASSEMBLY FOR A SEEDER COMPRISING AT LEAST ONE SEEDER ELEMENT, ASSOCIATED DOOR STORAGE DEVICE AND SEEDER

(71) Applicant: KUHN SAS, Saverne (FR)

(72) Inventors: Vincent GERARD, Brouviller (FR); Adrien CHANET, Brumath (FR)

(73) Assignee: KUHN SAS, Saverne (FR)

(21) Appl. No.: 19/261,148

(22) Filed: Jul. 7, 2025

(30) Foreign Application Priority Data
Jul. 25, 2024 (FR) FR2408223

(51) Int. Cl. A01C 15/00

(52) U.S. Cl. CPC A01C 15/006

(57) ABSTRACT

An assembly for a seeder including a seeder element and a hopper, the seeder element including a distribution device and a chassis component connected to the distribution device, the distribution device including a sealed housing including a fixed part and a movable door that can be moved between an open position in which the door is removed from the fixed part and a closed position, a distribution unit of a plurality of granular elements arranged to distribute a plurality of granular elements in a discrete and singular manner, wherein the assembly includes a storage device for the door configured to allow the door to be removably mounted with the hopper and/or the chassis component in the open position of the door.

### BACKGROUND OF THE INVENTION

### Field of the Invention

The present invention relates to the field of assemblies for a seeder comprising at least one seeder element, the field of door storage devices and the field of seeders.

The invention thus relates more generally to the field of single-seed seeding, which is also known as precision seeding, i.e. seeding in rows of seeds one by one. Single-seed seeding has applications in maize, beet, soybean and similar crops.

A single-seed seeder generally takes the shape of a beam frame on which seeder elements, generally between 4 and 12, or even more, are mounted by a parallelogram. The spacing between these seeder elements varies according to the crop, preferably between 37.5 centimeters and 80 centimeters, but makes it possible to form distinct rows. For this reason, it is common in this case to speak of row crops, as opposed to crops such as wheat where spacing is much closer.

As is known, a distribution device of a single-seed seeder generally functions as follows.

A two-part sealed housing includes a perforated dispensing disc, preferably driven in rotation by a motor, which forms a distribution unit of a plurality of granular elements. The dispensing disc separates the housing into two chambers with different air pressures, creating a positive or negative pressure difference on either side of the perforated dispensing disc. The housing is connected to a blower which allows the pressure difference to be controlled according to the type of seed, speed of advance and other parameters.

At the bottom of the perforated dispensing disc, i.e. at the bottom of the housing, there is a reserve area for granular elements, for example seeds, which is usually supplied by a hopper. These seeds are in contact with the rotating perforated dispensing disc, which, as it rotates, draws the seeds one by one into its perforations.

The diameter and shape of the perforations in the dispensing disc are designed to accommodate a single granular element, for example a seed. The granular element is held in the perforation by the pressure difference between the two sides of the dispensing disc. The perforations are often bordered by special shapes which are, for example, raised and/or recessed and are arranged in the dispensing disc in such a way as to guide and/or direct the seeds towards the perforation. These areas around the perforations are commonly referred to as agitators.

Once the seeds have been dispensed into the perforations of the dispensing disc, a so-called selection system eliminates any excess seeds to avoid duplicates, as several seeds may be lodged in a single perforation, which is not desirable. Selection can be made by teeth, brushes, or similar, which are fixedly mounted and located outside and/or inside the seed path. As a result, excess seeds fall back into the reserve area.

Once the seeds have been selected, they are transported to the last distribution area, which is generally located in the last quarter-turn of the dispensing disc, where the pressure difference is no longer present. As a result, excess seeds fall back into the reserve area. As a result of this lack of pressure difference, the seed is ejected from the perforation and exits the distribution unit towards the ground. Seed ejection can be assisted by a wheel which cuts the pressure difference and, if necessary, pushes the seed out of the perforation using pins.

In some situations, the movable door of the sealed housing must be opened, for example to change the dispensing disc and/or to carry out a cleaning and/or maintenance operation and/or seed emptying and/or distribution device operating adjustments.

To do so, in the distribution device, the operator unscrews the movable door from the fixed part by hand through a certain angle, for example an eighth of a turn. Once unscrewed, and thus in an open position, the operator finds himself with the movable door in his hands, which he generally places on the floor to leave his hands free to work on the fixed part of the housing.

As a result, the movable door is exposed to dust, dirt and so on. The operator may even inadvertently step on it, which may present a safety risk and obviously damage the movable door.

If the operator tries to balance it on the hopper lid, it will not be held securely in place, and may fall to the ground, damaging it and the components inside the movable door.

In theory, the operator can store the door in a storage box located on the front of the seeder or on the tractor, but this solution is not practical, especially as he will have to do this for each seeder element-some machines can have twenty of them, which is particularly time-consuming.

### DESCRIPTION OF THE RELATED ART

Publication EP4335271A1 illustrates these drawbacks in that the door can be completely removed and no storage solution is provided.

Document EP2683231B1 illustrates a distribution assembly which has the above-mentioned drawbacks. It features a door which can be completely removed from the fixed part of the distribution housing without providing a storage solution.

Document DE102017128854A1 illustrates a distribution assembly with quick-locking means used to mount an adapter on an opening on the door. However, it still has the above drawbacks, namely that no storage solution is provided for the door.

### SUMMARY OF THE INVENTION

The aim of the present invention is to remedy at least one of the aforementioned drawbacks.

The invention aims to provide a practical door storage solution so that an operator can quickly and easily store the door when it is in an open position.

To this end, the invention relates to an assembly for a seeder including at least one seeder element and optionally at least one hopper,
the seeder element including at least:
   a distribution device,
   a chassis component configured to be mounted on a beam frame of the seeder and being connected to the distribution device,
the distribution device including at least:
   a sealed housing including at least one fixed part and a movable door which can be moved between an open position in which the door is removed from the fixed part and a closed position,
   a distribution unit for a plurality of granular elements arranged to distribute a plurality of granular elements in a discrete and singular manner, the distribution unit being arranged inside the housing to separate the inside of the housing into a first chamber and a second chamber, which are distinct, the first chamber being configured to receive all or part of the plurality of granular elements, the door closing at least the first chamber or the second chamber in its closed position,
the fixed part or the door of the housing also includes a granular elements inlet opening into the first chamber,
the hopper optionally being arranged to store a plurality of granular elements and being connected to the granular elements inlet at least by conduction means,
the assembly further includes at least one door storage device configured to enable the door to be removably mounted with the hopper and/or the chassis component in the open position of the door.

The invention also relates to a distribution device housing door for an assembly according to the invention, wherein this door includes the second fastening element integrated into or arranged on the second outer wall of the door.

The invention also relates to a hopper for an assembly according to the invention, wherein the hopper includes the first fastening element integrated into or arranged on the first outer wall of the hopper.

The invention also relates to a seeder element for an assembly according to the invention, wherein the chassis component includes the first fastening element.

The invention also relates to a door storage device for an assembly according to the invention, wherein this device includes the first fastening element configured to be integrated into or arranged on the first outer wall of the hopper and/or on the chassis component and the second fastening element configured to be integrated into or arranged on the second outer wall of the door and being configured to be coupled with the first fastening element in the coupling position.

The invention also relates to a seeder including at least the assembly including at least one seeder element, at least one hopper and a beam frame, wherein the assembly is according to the invention.

### BRIEF DESCRIPTION OF THE DRAWINGS

The invention will be better understood from the following description, which refers to several preferred embodiments, given by way of non-limiting examples, and explained with reference to the appended schematic drawings, in which:

FIG. 1 shows a perspective view of the distribution device according to the invention of an assembly for a seeder according to the invention including a second fastening element in the form of a sleeve,

FIG. 2 shows a perspective view of a door of the distribution device shown in FIG. 1, including the second fastening element in the form of a sleeve,

FIG. 3 shows a side view of the door shown in FIG. 2,

FIG. 4 shows a perspective view from below of the door shown in FIG. 2,

FIG. 5 shows a perspective view of an alternative door of the distribution device including the second fastening element in the form of a sleeve and a second magnet,

FIG. 6 shows a perspective view of an individual hopper alternative of an assembly for a seeder according to the invention without a first fastening element,

FIG. 7 shows a side view of an individual hopper alternative of an assembly for a seeder according to the invention, with a first fastening element in the form of a hook,

FIG. 8 shows a perspective view of a detail of FIG. 7, depicting the first fastening element in the form of a hook,

FIG. 9 shows a perspective view of the individual hopper of FIG. 7 and the door of FIG. 2 with the first and second fastening elements in the coupling position,

FIG. 10 shows a perspective view of an individual hopper alternative of an assembly for a seeder according to the invention with a first fastening element in the form of a first magnet,

FIG. 11 shows a perspective view of an intermediate hopper alternative of an assembly for a seeder according to the invention without a first fastening element,

FIG. 12 shows a perspective view of an intermediate hopper alternative of an assembly for a seeder according to the invention with a first fastening element and the door with the second fastening element, the first fastening element and the second fastening element being in the coupling position,

FIG. 13 shows a perspective view of an assembly for a seeder according to an alternative embodiment of the invention, including the individual hopper shown in FIG. 7 and a distribution device including the door shown in FIG. 2,

FIG. 14 shows a perspective view of an assembly for a seeder according to an alternative embodiment of the invention, including the intermediate hopper with the first fastening element in the form of a hook, and the distribution device including the door shown in FIG. 2,

FIG. 15 shows a perspective view of an assembly for a seeder according to an alternative of the invention including the intermediate hopper of FIG. 11, the distribution device including the door shown in FIG. 5 and the first fastening element in the form of the first magnet mounted on a chassis component.

### DETAILED DESCRIPTION OF THE PREFERRED EMBODIMENTS

An assembly for a seeder includes at least one seeder element 1 and optionally at least one hopper 2, 2′,

The seeder element 1 including at least:
a distribution device 3,
a chassis component 4 configured to be mounted on a beam frame of the seeder and being connected to the distribution device 3,
the distribution device 3 including at least:
a sealed housing 5 including at least one fixed part 6 and a movable door 7 which can be moved between an open position in which the door 7 is removed from the fixed part 6 and a closed position POFF,
a distribution unit for a plurality of granular elements arranged to distribute a plurality of granular elements in a discrete and singular manner, the distribution unit being arranged inside the housing 5 to separate the interior of the housing 5 into a first chamber and a second chamber, which are distinct, the first chamber being configured to receive all or part of the plurality of granular elements, the door 7 closing at least the first chamber or the second chamber in its closed position POFF,
the fixed part 6 or the door 7 of the housing 5 also includes a granular element inlet opening into the first chamber,
optionally the hopper 2, 2′ being arranged to store a plurality of granular elements and being connected to the granular elements inlet at least by conduction means 8.

According to the invention, the assembly is characterized in that it further includes at least one storage device 9 for the door 7 configured to allow the door 7 to be removably mounted with the hopper 2, 2′ and/or the chassis component 4 in the open position of the door 7.

Advantageously, this configuration enables to provide a means for storing the door 7 on certain parts of the seeder element 1, and therefore as close as possible to the operator. When removed from the fixed part 6 and when stored, the door 7 can be reversibly mounted on the hopper 2, 2′ and/or on the chassis component 4. It can then be reversibly removed from the hopper 2, 2′ and/or the chassis component 4 and, if necessary, replaced on the fixed part 6 in the closed position POFF. As a result, the invention offers a practical solution for storing the door 7, so that an operator can store the door 7 easily and quickly when it is in an open position. The invention also offers other advantages. The operator does not need to travel far or contort his body between the seeder elements 1 in order to store the door 7, which saves time and increases convenience. The door 7 stays clean and off the floor. The solution is suitable for all types of hoppers 2, 2′ and all types of machine configurations. Full access to the housing 5 is maintained, with full opening by removing the door 7.

Preferably, the storage device 9 for the door 7 includes at least one first fastening element 10 integrated into or arranged on a first outer wall 11, 11′ of the hopper 2, 2′ and/or of the chassis component 4 and a second fastening element 12 integrated into or arranged on a second outer wall 13 of the door 7 and being configured to be coupled with the first fastening element 10 in a coupling position PC.

Advantageously, in this preferred example, the storage device 9 enables the door 7 to be hooked onto the hopper 2, 2′ and/or the chassis component 4. As a result, the solution provides secure and stable storage of the door 7. Assembly/disassembly has the advantage of being tool-free.

Preferably, according to a first embodiment alternative, the first fastening element 10 includes a hook 14 and the second fastening element 12 includes a sleeve 15 into which the hook 14 is inserted in the coupling position PC so as to achieve a mechanical coupling.

Advantageously, industrialization is simple and inexpensive. Moreover, the addition of the hook 14 does not lead to any loss of volume in the hopper 2, 2′. Advantageously, the sleeve 15 can also fulfil another function for the operation of the distribution device 3. For example, the sleeve 15 can also serve as an air exhaust pipe for the distribution device 3.

Preferably according to a second alternative embodiment, the first fastening element 10 includes a first magnet 16 or a first magnetizable part and the second fastening element 12 includes a second magnet 17 or a second magnetizable part, the first magnet 16 and the second magnet 17 or the first magnet 16 and the second magnetizable part or the first magnetizable part and the second magnet 17 being magnetized to one another in the coupling position PC so as to achieve a magnetic coupling.

Advantageously, industrialization is simple and inexpensive. Moreover, the addition of the first magnet 16 or the first magnetizable part does not lead to any loss of volume in the hopper 2, 2′.

Preferably, the invention extends to a second fastening element 10 including a sleeve 15 and a second magnet 17.

Preferably, the assembly includes a single seeder element 1 associated with a single individual or intermediate hopper 2, 2′ and a single storage device 9.

Alternatively, the assembly includes a plurality of seeder elements 1 and a plurality of individual hoppers 2 and a plurality of storage devices 9, each seeder element 1 being associated with a hopper 2 so as to form a sub-assembly and having a dedicated storage device 9 for each door 7.

Advantageously, in both of the above cases, each door 7 is associated with a storage device 9. For example, during storage, each door 7 can be mounted by the storage device 9 on each hopper 2, or each door 7 can be mounted by the storage device 9 on each chassis component 4. Preferably, each door 7 has a second fastening element 12 and each hopper 2 or each chassis component 4 has a first fastening element 10.

Alternatively, the assembly includes a plurality of seeder elements 1, a single central tank (not shown) and a plurality of intermediate hoppers 2′, each seeder element 1 being connected to the central tank and a plurality of storage devices 9, each seeder element 1 being associated with an intermediate hopper 2′ so as to form a sub-assembly and having a dedicated storage device 9 for each door 7.

Advantageously, in this configuration, during storage, each door 7 can be mounted by the storage device 9 on each chassis component 4 or the plurality of doors 7 can be mounted by the storage device 9 on the intermediate hoppers 2′. In the latter case, each door 7 preferably has a second fastening element 12, and the intermediate hoppers 2′ each have a first fastening element 10.

According to a possible alternative not shown, the assembly may include a plurality of seeder elements 1, each associated with a single central tank, and at least one storage device 9. This alternative is however not suitable for all types of seed, as some types of seed require the use of intermediate hoppers 2′. In order to offer a more versatile solution, the solution with intermediate hoppers 2′ is therefore preferred.

The invention also relates to a door 7 of a housing 5 of a distribution device 3 for an assembly according to the invention, wherein the door includes the second fastening element 12 integrated into or arranged on the second outer wall 13 of the door 7.

The invention also relates to a hopper for an assembly according to the invention, wherein the hopper includes the first fastening element 10 integrated into or arranged on the first outer wall 11 of the hopper 2, 2′.

The invention also relates to a seeder element for an assembly according to the invention, wherein the chassis component 4 includes the first fastening element 10.

The invention also relates to a storage device 9 of the door 7 for an assembly according to the invention, wherein the storage device 9 includes the first fastening element 10 configured to be integrated into or arranged on the first outer wall 11, 11′ of the hopper 2, 2′ and/or of the chassis component 4, and the second fastening element 12 configured to be integrated into or arranged on the second outer wall 13 of the door 7 and being configured to be coupled with the first fastening element 10 in the coupling position PC.

The invention also relates to a seeder including at least the assembly including at least one seeder element 1, at least one hopper 2, 2′ and a beam frame, wherein the assembly is according to the invention.

The seeder element 1 includes at least the distribution device 3 and the chassis component 4.

The hopper 2, 2′ is used to store granular elements, such as seeds or inputs in granular form. The hopper 2, 2′ forms a container preferably closed by a lid 23.

The hopper 2, 2′ can be individual, intermediate or central. In the case of an individual hopper 2, it is associated with a single seeder element 1 and is connected to the inlet. If a central tank is provided to store the granular elements, the connection to the inlet is preferably made via an intermediate hopper 2′ which is connected on one hand to the inlet by conduction means 8 and on another hand to the central tank by additional pipe-type conduction means 8′. Alternatively, if only a central tank is provided without an intermediate hopper 2′ that forms a central hopper, then the inlet connection is made by other duct-type conduction means. Alternatively again, an individual hopper 2 can be used in parallel with a connection between a central tank and the seeder elements 1. In this configuration, both the individual hopper 2 and the central tank are connected to the seed inlet. Their use is therefore selective, depending on the type of seed to be seeded. It may be advantageous to use a central tank for seed feeding when seeding certain types of seed, and an individual hopper 2 feeding system when seeding other types of seed. These situations are defined by the characteristics of the seeds to be seeded, for example their size or the presence or absence of coatings and/or treatments on the seeds. In this alternative configuration, the individual hopper 2 may have dimensions close to those of the individual hoppers 2 used in the other configurations, or be reduced in size, for example with dimensions similar to the intermediate hoppers 2′.

The distribution device 3 includes the housing 5 and the distribution unit, preferably in the form of a perforated dispensing disc driven in rotation, preferably by a motor. The dispensing disc divides the housing into two chambers, the first chamber and the second chamber, in which the air pressures are preferably different. The first and second chambers are preferably substantially cylindrical in shape. Door 7 preferably accommodates the dispensing disc, but this example is not limitative.

The housing 5 includes the fixed part 6 and the door 7 which is movable with respect to the fixed part 6 and allows the housing 5 to be opened to provide access to the inside of the housing 5 or to close it. The door 7 thus adopts either an open or a closed POFF position. In the open position, the door 7 can be completely removed from the fixed part 6. The door 7 is preferably cylindrical in shape and has a flat bottom.

The chassis component 4 is mechanically connected to the distribution device 3, preferably to the fixed part 6 of the housing 5. It preferably includes at least one fastening parallelogram 31 configured to be connected to the beam frame (not shown) and optionally a support cradle 30 configured to be connected to the hopper 2, 2′.

The conduction means 8 connect the hopper 2, 2′ to the first chamber (not shown) of the housing 5 and thus open onto the inlet (not shown). The conduction means 8 preferably include at least one pipe and preferably a lower pipe (not shown) and an upper pipe 8a. The lower pipe opens into the first chamber via the inlet. The upper pipe 8a is designed to be connected to the hopper 2, 2′ and to the lower pipe.

The purpose of the storage device 9 is to enable the door 7 to be reversibly mounted on and removed from the hopper 2, 2′ and/or the chassis component 4.

In a preferred example, the storage device 9 preferably includes a sub-assembly including the first fastening element 10 and the second fastening element 12. In this case, mounting/removal has the advantage of being tool-free. This example is not limitative, and other solutions could be conceived involving the use of tools, such as screw mounting.

The first fastening element 10 and the second fastening element 12 are designed to cooperate with each other in the coupling position PC and are designed to enable the door 7 to be hooked to the hopper 2, 2′ and/or to the chassis component 4.

The first outer wall 11 of the hopper 2, 2′ preferably has four lateral outer faces 18, 19, 19′, 20, a lower outer face 21 and an upper outer face 22. The upper outer face 22 is preferably provided with the lid 23. The upper outer face 22 may include an inlet 29 connected to the additional conduction means 8′. The lower outer face 21 preferably includes an outlet 26 which can be connected to the conduction means 8 and in particular to the upper pipe 8a.

Preferably, the first fastening element 10 is mounted on the lower outer face. This facilitates access when the operator is facing the distribution device 3. Alternatively, the first fastening element 10 can be mounted on one of the lateral outer faces, the upper outer face or on the lid.

The first outer wall 11′ of the chassis component 4 includes an outer wall of the fastening parallelogram 31 and/or of the support cradle 30.

Preferably, the first fastening element 10 is mounted on the outer wall of the fastening parallelogram 31 and/or the support cradle 30.

The second outer wall 13 of the door 7 preferably has the shape of a circular cylinder with a bottom.

Preferably, the second fastening element 12 is mounted on the outside face of the bottom.

The first fastening element 10 and/or the second fastening element 12 can be fixed respectively to the first outer wall 11, 11′ and to the second outer wall 13 by fixing means.

In this case, the first fastening element 10 and the second fastening element 12 are parts attached respectively to the door 7 and to the hopper 2, 2′ and/or to the chassis component 4.

The hook 14 can include a mounting section 27 connected to the first outer wall 11 of the hopper 2, 2′ and/or of the chassis component 4, for example by screwing, and an insertion section 28 which rests on the first outer wall 11 and extends vertically. The mounting section 27 can be U-shaped and the insertion section 28 can be tooth-shaped, centered on the base of the U.

The sleeve 15 preferably has a channel 24 into which the insertion section 28 of the hook 14 can be inserted.

The sleeve 15 is preferably a part attached to the second outer wall 13 of the door 7 by screwing.

For this purpose, the channel 24 and the insertion section 28 have complementary shapes.

The first magnet 16 or the second magnet 17 have the shape of a square plate, for example.

The second magnet 17 is mounted on the outer wall 25 of the sleeve 15, for example by gluing or screwing.

The first magnetizable part is preferably a portion of the hopper 2 and/or chassis component 4, which is made of ferromagnetic material.

The second magnetizable part is preferably a portion of the door 7 made of ferromagnetic material.

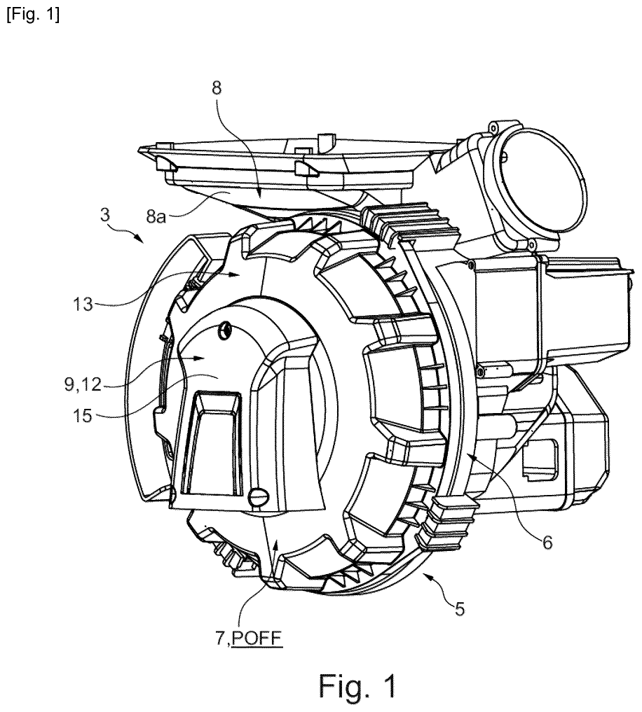

FIG. 1 shows the distribution device 3 according to the invention of the assembly for a seeder according to the invention. The distribution device 3 includes the sealed housing 5 including the fixed part 6 and the movable removable door 7 which is in the closed position POFF. In addition, the second fastening element 12 is arranged on the second outer wall 13 of the door 7 and takes the form of a sleeve 15. The sleeve 15 is a part attached to the second outer wall 13 of the door 7 by screwing. The conduction means 8 are also visible and are connected to the first chamber of the housing 5. The upper pipe 8a is designed to be connected to the outlet 26 of the hopper 2, 2′ and to the lower pipe which opens onto the inlet.

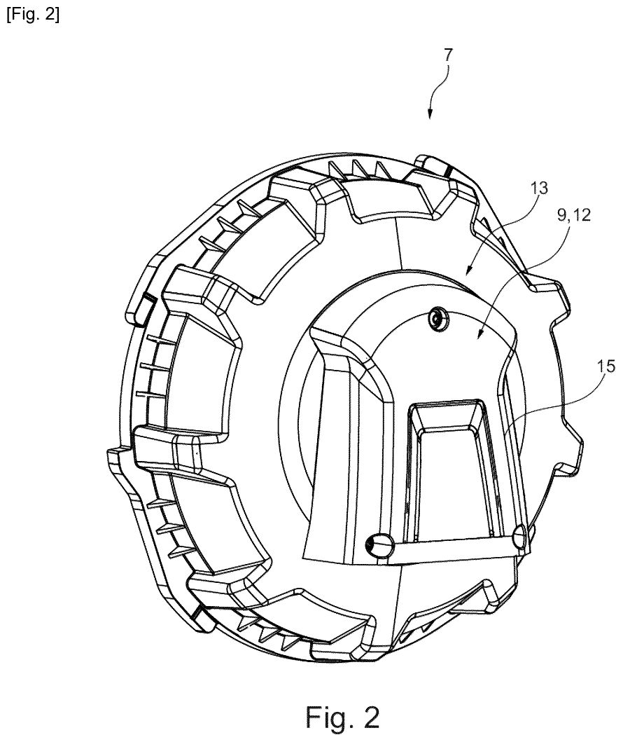

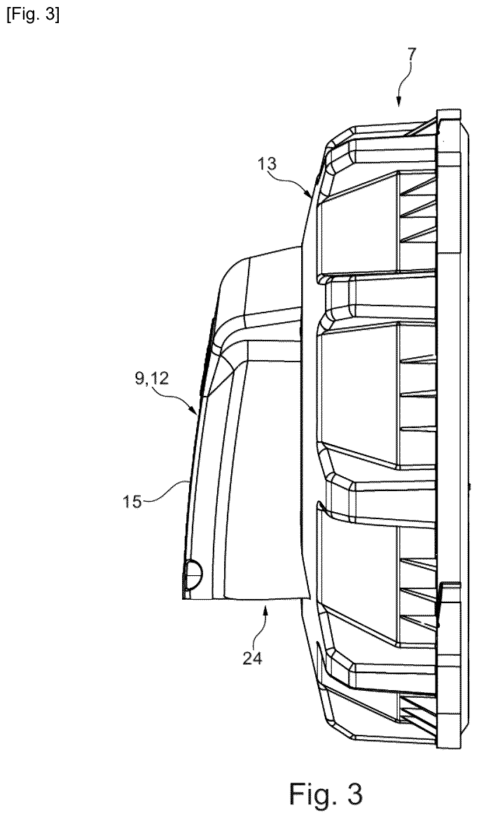

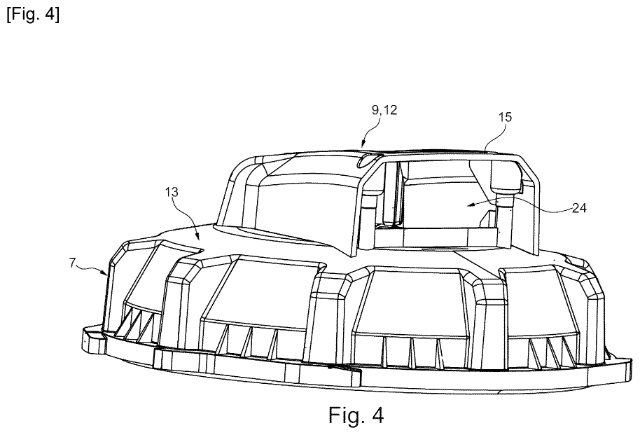

FIGS. 2 to 4 illustrate the movable door 7 shown in FIG. 1 with the second fastening element 12, which is arranged on the second outer wall 13 of the door 7 and takes the form of a sleeve 15. The sleeve 15 is a part fixed to the second outer wall 13 of the door 7 by screwing. The sleeve 15 features the channel 24.

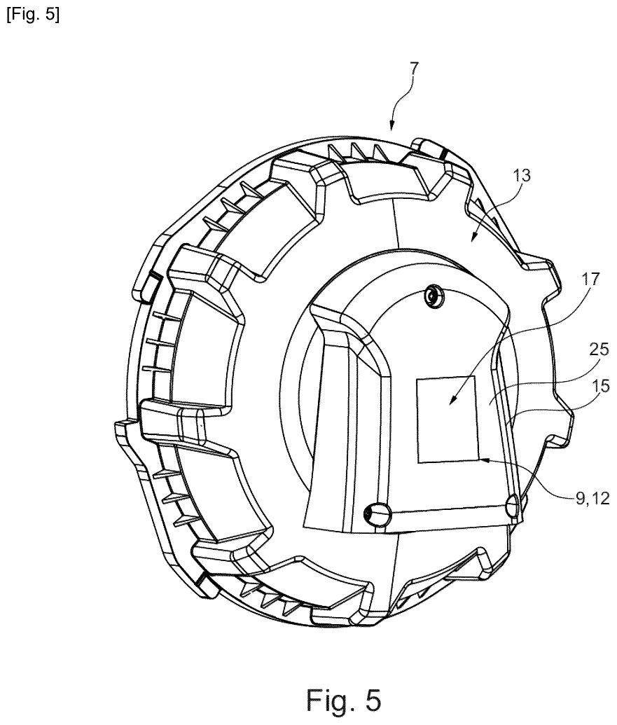

FIG. 5 shows another possible alternative of the door 7 with the second fastening element 12, which is arranged on the second outer wall 13 of the door 7 and takes the form of a sleeve 15 and a second magnet 17. The sleeve 15 is a part fixed to the second outer wall 13 of the door 7 by screwing. The second magnet 17 is mounted on the outer wall 25 of the sleeve 15.

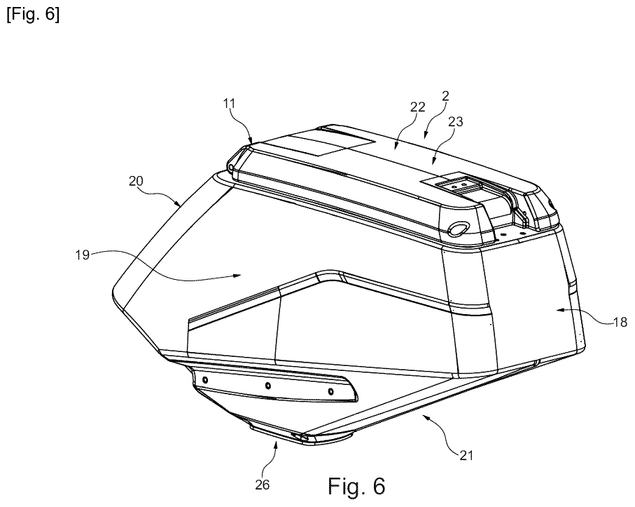

FIG. 6 shows an alternative of an individual hopper 2 of an assembly for a seeder according to the invention without a first fastening element 10. The first outer wall 11 of the hopper 2 has four lateral outer faces 18, 19, 20, a lower outer face 21 and an upper outer face 22. The upper outer face 22 is provided with the lid 23. The lower outer face 21 includes the outlet 26 which can be connected to the conduction means 8.

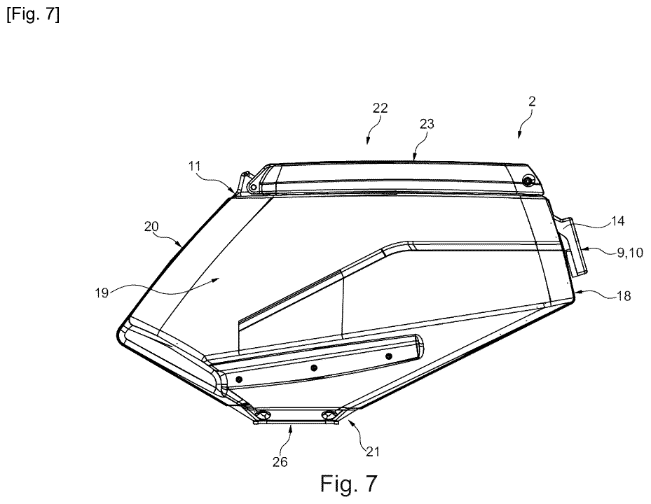

FIG. 7 shows an alternative of an individual hopper 2 of an assembly for a seeder according to the invention with a first fastening element 10 in the form of hook 14. This alternative differs from that shown in FIG. 6 by the addition of the hook 14, which is mounted on the front lateral outer face 18.

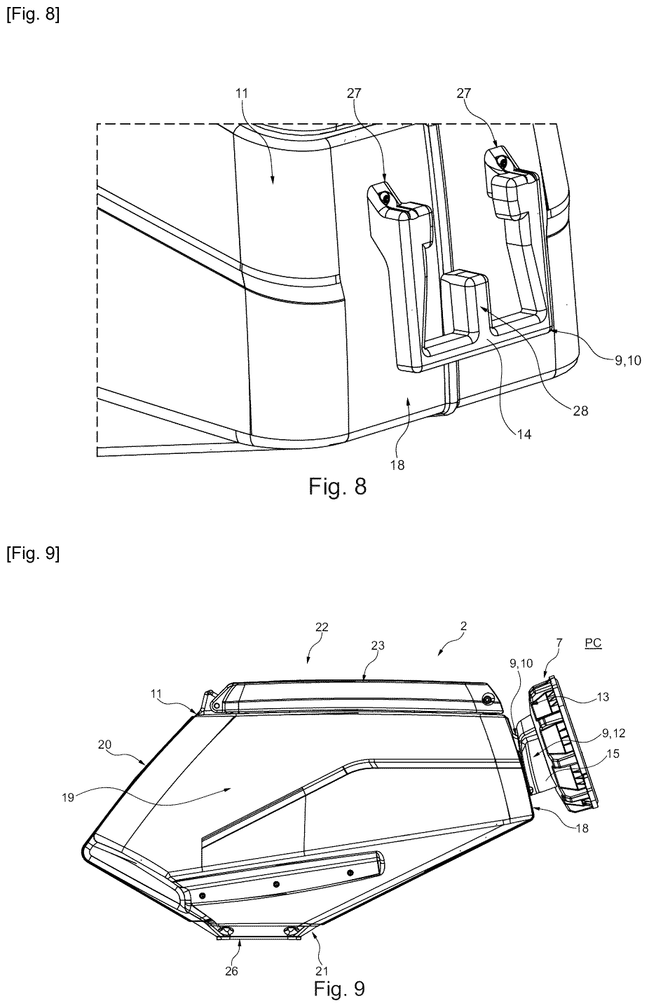

FIG. 8 shows in detail the first fastening element 10 in the form of the hook 14. The hook 14 includes the mounting section 27 mounted on the front lateral outer face 18 of the first outer wall 11 by screwing and the vertically extending insertion section 28 which rests on the front lateral outer face 18 of the first outer wall 11. The mounting section 27 is U-shaped and the insertion section 28 is tooth-shaped, centered on the base of the U.

FIG. 9 shows the individual hopper 2 of FIG. 7 and the door 7 of FIG. 2 with the first fastening element 10 and the second fastening element 12 in the coupling position PC. The storage device 9 of the door 7 enables the door 7 to be removably mounted with the individual hopper 2.

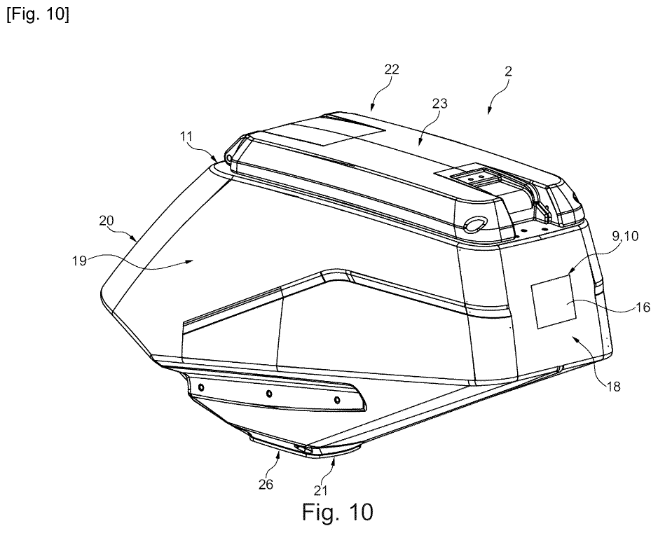

FIG. 10 shows an alternative of an individual hopper 2 of an assembly for a seeder according to the invention with a first fastening element 10 in the form of the first magnet 16. This alternative differs from that shown in FIG. 6 by the addition of a first magnet 16 which is mounted on the front lateral outer face 18.

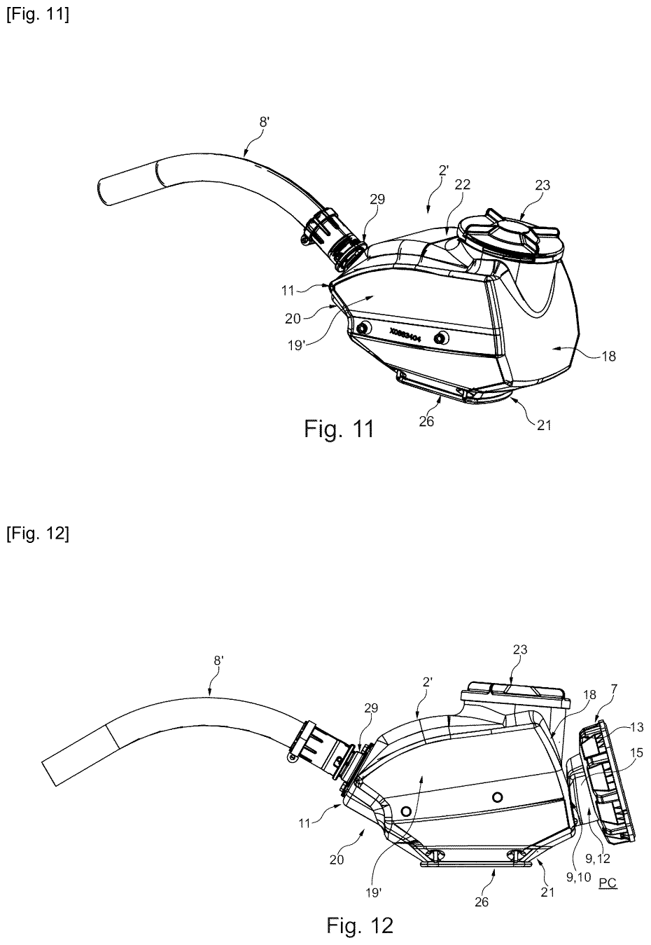

FIG. 11 shows a perspective view of an alternative of an intermediate hopper 2′ of an assembly for a seeder according to the invention without a first fastening element. The first outer wall 11 of the intermediate hopper 2′ has four lateral outer faces 18, 19′, 20, a lower outer face 21 and an upper outer face 22. The upper outer face 22 is provided with the lid 23 and an inlet 29 connected to the additional conduction means 8′. The lower outer face 21 includes the outlet 26 which can be connected to the conduction means 8 and in particular to the upper pipe 8a.

FIG. 12 shows a perspective view of an alternative of an intermediate hopper 2′ of an assembly for a seeder according to the invention with a first fastening element 10 and the door 7 with the second fastening element 12. The intermediate hopper 2′ differs from that of FIG. 11 by the addition of a first fastening element 10 which is mounted on the front lateral face 18. The first fastening element 10 and the second fastening element 12 are in the coupling position PC. The storage device 9 of the door 7 allows the door 7 to be removably mounted with the intermediate hopper 2′.

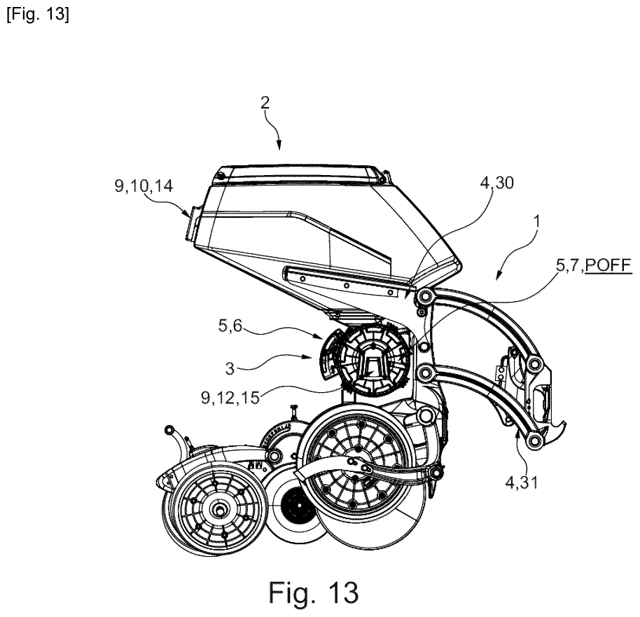

FIG. 13 shows an assembly for a seeder according to an alternative embodiment according to the invention including in particular the individual hopper 2 of FIG. 7 with the first fastening element 10 in the form of a hook 14 and a seeder element 1 including a chassis component 4 and in particular the distribution device 3 including the door 7 shown in FIG. 2 in the closed position POFF with a second fastening element 12 in the form of a sleeve 15. The individual hopper 2 is mounted on the chassis component 4 forming a support cradle 30. The chassis component 4 also includes a fastening parallelogram 31 configured to be connected to the beam frame.

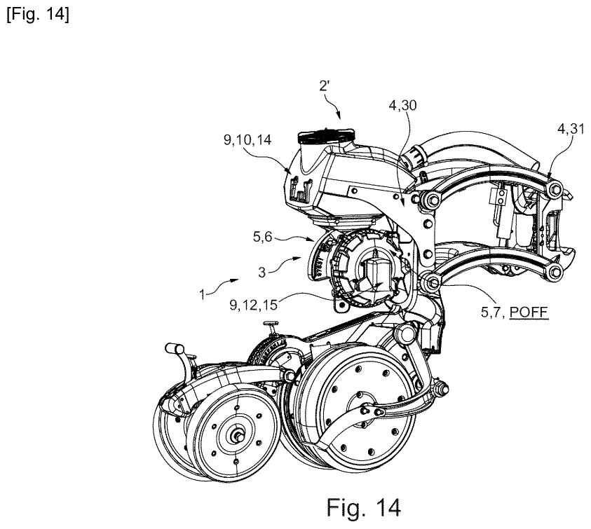

FIG. 14 shows an assembly for a seeder according to an alternative embodiment according to the invention including the intermediate hopper 2′ with the first fastening element 10 in the form of a hook 14 and a seeder element 1 including a chassis component 4 and in particular the distribution device 3 including the door 7 shown in FIG. 2 in the closed position POFF with a second fastening element 12 in the form of a sleeve 15. The intermediate hopper 2′ is mounted on the chassis component 4 forming a support cradle 30. The chassis component 4 also includes a fastening parallelogram 31 configured to be connected to the beam frame.

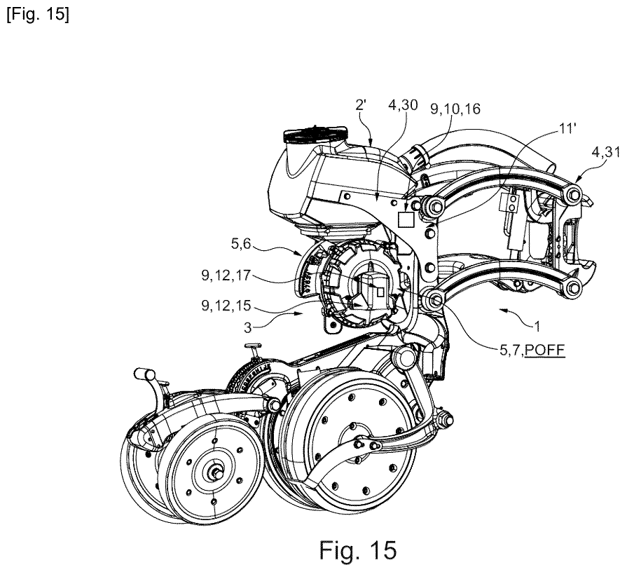

FIG. 15 shows an assembly for a seeder according to an alternative embodiment according to the invention including the intermediate hopper 2′ shown in FIG. 11 and a seeder element 1 including in particular a chassis component 4 and the distribution device 3 including the door 7 shown in FIG. 5 in the closed position POFF with a second fastening element 12 in the form of a sleeve 15 and a second magnet 17. The intermediate hopper 2′ is mounted on the chassis component 4 forming a support cradle 30 and the first fastening element 10 in the form of the first magnet 16 is mounted on the outer wall of this chassis component 4 forming the support cradle 30 and corresponding to the first outer wall 11′. The chassis component 4 further includes a fastening parallelogram 31 configured to be connected to the beam frame.

Of course, the invention is not limited to the embodiments described and shown in the appended drawings. Modifications remain possible, in particular with regard to the constitution of the various elements or by substitution of technical equivalents, without however falling outside the field of protection of the invention.

1. An assembly for a seeder including a seeder element and optionally a hopper,
the seeder element including at least:
a distribution device,
a chassis component configured to be mounted on a beam frame of the seeder and being connected to the distribution device,
the distribution device including at least:
a sealed housing including a fixed part and a movable door which can be moved between an open position in which the door is removed from the fixed part and a closed position,
a distribution unit for a plurality of granular elements arranged to distribute a plurality of granular elements in a discrete and singular manner, the distribution unit being arranged inside the housing to separate the inside of the housing into a first chamber and a second chamber, which are distinct, the first chamber being configured to receive all or part of the plurality of granular elements, the door closing at least the first chamber or the second chamber in its closed position,
the fixed part or door of the housing also includes a granular elements inlet opening into the first chamber,
the hopper optionally being arranged to store a plurality of granular elements and being connected to the granular elements inlet at least by conduction means,
wherein the assembly further includes a door storage device configured to enable the door to be removably mounted with the hopper and/or chassis component in the open position of the door.

2. The assembly according to claim 1, wherein the door storage device includes at least a first fastening element integrated into or arranged on a first outer wall of the hopper and/or on the chassis component and a second fastening element configured to be integrated into or arranged on a second outer wall of the door and being configured to be coupled with the first fastening element in a coupling position.

3. The assembly according to claim 1, wherein the first fastening element includes a hook and the second fastening element includes a sleeve into which the hook is inserted in the coupling position so as to achieve a mechanical coupling.

4. The assembly according to claim 1, wherein the first fastening element includes a first magnet or a first magnetizable part and the second fastening element includes a second magnet or a second magnetizable part, the first magnet and the second magnet or the first magnet and the second magnetizable part or the first magnetizable part and the second magnet being magnetized to one another in the coupling position so as to achieve a magnetic coupling.

5. The assembly according to claim 1, wherein the assembly includes a single seeder element associated with a single individual or intermediate hopper and a single storage device.

6. The assembly according to claim 1, wherein the assembly includes a plurality of seeder elements and a plurality of individual hoppers and a plurality of storage devices, each seeder element being associated with a hopper so as to form a sub-assembly and having a dedicated storage device for each door.

7. The assembly according to claim 1, wherein the assembly includes a plurality of seeder elements, a single central tank and a plurality of intermediate hoppers, each seeder element being connected to the central tank and a plurality of storage devices, each seeder element being associated with an intermediate hopper so as to form a sub-assembly and having a dedicated storage device for each door.

8. A seeder including at least the assembly including a seeder element, a hopper and a beam frame, wherein the assembly is according to claim 1.
